(19) United States
(12) Patent Application Publication
(10) Pub. No.: US 2019/0006055 A1
(43) Pub. Date: Jan. 3, 2019

(54) TREATMENT METHOD OF RADIOACTIVE WASTE WATER CONTAINING RADIOACTIVE CESIUM AND RADIOACTIVE STRONTIUM

(71) Applicants: EBARA CORPORATION, Tokyo (JP); NIPPON CHEMICAL INDUSTRIAL CO., LTD., Tokyo (JP)

(72) Inventors: Takashi SAKUMA, Tokyo (JP); Makoto KOMATSU, Tokyo (JP); Takeshi IZUMI, Tokyo (JP); Shinsuke MIYABE, Tokyo (JP); Yutaka KINOSE, Tokyo (JP); Kenta KOZASU, Tokyo (JP); Eiji NOGUCHI, Tokyo (JP); Takeshi SAKAMOTO, Tokyo (JP)

(21) Appl. No.: 16/060,323

(22) PCT Filed: Dec. 6, 2016
(86) PCT No.: PCT/JP2016/086127

§ 371 Date: Jun. 7, 2018

(30) Foreign Application Priority Data
Dec. 10, 2015 (JP) 2015-240942

(51) Int. Cl. G21F 9/12; B01J 20/10; B01J 20/28

(52) U.S. Cl. CPC G21F 9/12; B01J 20/10; G21Y 2002/10; G21Y 2004/10; B01J 20/28002

(57) ABSTRACT

A treatment method of radioactive waste water containing radioactive cesium and radioactive strontium, comprising passing the radioactive waste water containing radioactive cesium and radioactive strontium through an adsorption column packed with an adsorbent for cesium and strontium, to adsorb the radioactive cesium and radioactive strontium on the adsorbent, wherein the adsorbent for cesium or strontium comprises a crystalline silicotitanate having a crystallite diameter of 60 Å or more and having a half width of 0.9° or less of the diffraction peak in the lattice plane (100), the crystalline silicotitanate represented by the general formula: A₄Ti₄Si₃O₁₆.nH₂O.

### TECHNICAL FIELD

The present invention relates to a treatment method of radioactive waste water containing radioactive cesium and radioactive strontium, in particular, a treatment method of radioactive waste water for removing both elements, the radioactive cesium and the radioactive strontium contained in the waste water containing contaminating ions such as seawater, generated in a nuclear power plant.

### BACKGROUND ART

The accident caused by the Great East Japan Earthquake on Mar. 11, 2011, in the Fukushima Daiichi Nuclear Power Station, has generated a large amount of radioactive waste water containing radioactive iodine. The radioactive waste water includes: the contaminated water generated due to the cooling water poured into a reactor pressure vessel, a reactor containment vessel, and a spent fuel pool; the trench water accumulated in a trench; the subdrain water pumped up from a well called a subdrain in the periphery of a reactor building; groundwater; and seawater (hereinafter, referred to as “radioactive waste water”). Radioactive substances are removed from these radioactive waste waters by using a treatment apparatus called, for example, SARRY (Simplified Active Water Retrieve and Recovery System (a simple type contaminated water treatment system) cesium removing apparatus) or ALPS (a multi-nuclide removal apparatus), and the water thus treated is collected in a tank.

Examples of a substance capable of selectively adsorbing and removing radioactive cesium among radioactive substances include ferrocyanide compounds such as iron blue, mordenite being a type of zeolite, an aluminosilicate, and titanium silicate (CST). For example, in SARRY, in order to remove radioactive cesium, IE96 manufactured by UOP LLC, an aluminosilicate, and IE911 manufactured by UOP LLC, a CST are used. Examples of a substance capable of selectively adsorbing and removing radioactive strontium include natural zeolite, synthetic A-type and X-type zeolite, a titanate salt, and CST. For example, in ALPS, in order to remove radioactive strontium, an adsorbent, a titanate salt is used.

In “Contaminated Liquid Water Treatment for Fukushima Daiichi NPS (CLWT)” (NPL 1) published by Division of Nuclear Fuel Cycle and Environment in the Atomic Energy Society of Japan, the cesium and strontium adsorption performances of IE910 manufactured by UOP LLC, a powdery CST, and IE911 manufactured by UOP LLC, a beaded CST, have been reported that the powdery CST has a capability of adsorbing radioactive cesium and strontium, and the granular CST is high in the cesium adsorption performance but low in the strontium adsorption performance.

It has also been reported that a modified CST obtained by surface treating a titanium silicate compound by bringing a sodium hydroxide aqueous solution having a sodium hydroxide concentration within a range of 0.5 mol/L or more and 2.0 mol/L into contact with the titanium silicate compound achieves a cesium removal efficiency of 99% or more and a strontium removal efficiency of 95% or more (PTL 1).

The powdery CST can be used, for example, in a treatment method based on flocculation, but is not suitable for the method by passing the water to be treated through a column packed with an adsorbent, adopted in SARRY and ALPS.

In order to improve the strontium adsorption performance of the granular CST, the treatments and the operations shown in PTL 1 and NPL 2 have been investigated, but such treatments and operations require large amounts of chemicals so as to lead to a cost increase.

Accordingly, there is demanded a treatment method of radioactive waste water, being high in the adsorption performances of both of cesium and strontium without performing cumbersome treatments and operations, and using a granular CST suitable for the treatment method of passing water through an adsorption column. On the other hand, CST is weak against heat, undergoes composition change when strongly heated, and the capabilities of adsorbing cesium and strontium are degraded. In a zeolite molded body, a binder such as a clay mineral is used, and the zeolite molded body is fired at 500° C. to 800° C. to improve the strength of the molded body; however, the adsorption capability of CST is degraded by heating strongly as described above, and accordingly CST cannot be fired. Therefore, it has been necessary to form a granular CST without heating strongly.

It, has also been reported that the sodium ions have a tendency to suppress the ion-exchange reaction between the radioactive cesium and CST (NPL 2), and thus there is a problem that the removal performance of the radioactive cesium and the radioactive strontium from high-concentration seawater is degraded.

For the purpose of enhancing the adsorption performance of cesium and strontium from seawater containing sodium ions, the present inventors have proposed an adsorbent for cesium and strontium including: at least one selected from crystalline silicotitanates represented by the general formulas: Na₄Ti₄Si₃O₁₆.nH₂O, (NaₓK₍₁₋ₓ₎)₄Ti₄Si₃O₁₆.nH₂O and K₄Ti₄Si₃O₁₆.nH₂O wherein x represents a number of more than 0 and less than 1, and n represents a number of 0 to 8; and at least one selected from titanate salts represented by the general formulas: Na₄Ti₉O₂₀.mH₂O, (Na_{y}K₍₁₋₄₎)₄Ti₉O₂₀mH₂O and K₄Ti₉O₂₀.mH₂O wherein y represents a number of more than 0 and less than 1, and m represents a number of 0 to 10, as well as a method for producing the adsorbent (PTL 2).

### CITATION LIST

### Patent Literature

PTL 1: Japanese Patent No. 5285183
PTL 2: Japanese Patent No. 5696244

### Non Patent Literature

NPL 1: “Contaminated Liquid Water Treatment for Fukushima Daiichi NPS (CLWT)” http://www.nuce-aesj.org/projects:clwt:start
NPL 2: JAEA-Research 2011-037

### SUMMARY OF INVENTION

### Technical Problem

An object of the present invention is to provide a treatment method of and a treatment apparatus for radioactive waste water, capable of removing both of radioactive cesium and radioactive strontium with a high removal efficiency and simply, by a method of passing water to be treated through a column packed with an adsorbent.

### Solution to Problem

As a result of a diligent study in order to solve the above-described problem, the present inventors have found that both of radioactive cesium and radioactive strontium can be removed simply and efficiently by passing radioactive waste water through an adsorption column packed with a specific adsorbent under a specific water passing conditions, and have completed the present invention.

The present invention includes the following aspects.

[1] A treatment method of radioactive waste water containing radioactive cesium and radioactive strontium, comprising passing the radioactive waste water containing radioactive cesium and radioactive strontium through an adsorption column packed with an adsorbent for cesium and strontium, to adsorb the radioactive cesium and radioactive strontium on the adsorbent, wherein the adsorbent comprises a crystalline silicotitanate having a crystallite diameter of 60 Å or more and having a half width of 0.9° or less of the diffraction peak in the lattice plane (100), the crystalline silicotitanate represented by the general formula: A₄Ti₄Si₃O₁₆.nH₂O wherein A is Na or K or a combination thereof, and n represents a number of 0 to 8, wherein the adsorbent for cesium and strontium is a granular adsorbent having a grain size of 250 μm or more and 1200 μm or less, wherein the absorbent is packed to a height of 10 cm or more and 300 cm or less in the adsorption column, and wherein the radioactive waste water is passed through the adsorption column at a linear velocity (LV) of 1 m/h or more and 40 m/h or less and a space velocity (SV) of 200 h⁻¹ or less.

[2] The treatment method according to [1], wherein the radioactive waste water is waste water containing a Na ion, a Ca ion and/or a Mg ion.

[3] The treatment method according to [1] or [2], wherein the adsorbent comprises 99.5% by mass or more of the crystalline silicotitanate.

### Advantageous Effects of Invention

According to the present invention, both of radioactive cesium and radioactive strontium can be removed with a high removal efficiency and simply by a treatment method of passing water to be treated through an adsorption column packed with an adsorbent.

### BRIEF DESCRIPTION OF DRAWINGS

FIG. 1 shows the X-ray diffraction spectrum of the adsorbent produced in Production Examples 1 to 3.

FIG. 2 is a graph showing the cesium adsorption removal performance in Example 2.

FIG. 3 is a graph showing the strontium adsorption removal performance in Example 2.

FIG. 4 is a graph showing the cesium adsorption removal performance in Example 3.

FIG. 5 is a graph showing the strontium adsorption removal performance in Example 3.

### DESCRIPTION OF EMBODIMENTS

The present invention relates to a treatment method of radioactive waste water containing radioactive cesium and radioactive strontium, comprising passing the radioactive waste water containing radioactive cesium and radioactive strontium through an adsorption column packed with an adsorbent for cesium and strontium, to adsorb the radioactive cesium and radioactive strontium on the adsorbent, wherein the adsorbent for cesium and strontium comprises a crystalline silicotitanate having a crystallite diameter of 60 Å or more and having a half width of 0.9° or less of the diffraction peak in the lattice plane (100), the crystalline silicotitanate represented by the general formula: A₄Ti₄Si₃O₁₆.nH₂O wherein A is Na or K or a combination thereof, and n represents a number of 0 to 8, wherein the adsorbent for cesium and strontium is a granular adsorbent having a grain size of 250 μm or more and 1200 μm or less, wherein the absorbent is packed to a height of 10 cm or more and 300 cm or less in the adsorption column, and wherein the radioactive waste water is passed through the adsorption column at a linear velocity (LV) of 1 m/h or more and 40 m/h or less and a space velocity (SV) of 200 h⁻¹ or less.

The adsorbent used in the treatment method of the present invention includes a specific crystalline silicotitanate. The silicotitanate has, in an X-ray diffraction analysis using Cu-Kα line as an X-ray source, the half width of the main diffraction peak of 2θ=10° or more and 13° or less is 0.9° or less, preferably 0.3° or more and 0.9° or less, and more preferably 0.3° or more and 0.8° or less; the crystallite diameter obtained by the Scherrer equation on the basis of the aforementioned half width is 60 Å or more, preferably 60 Å or more and 250 Å or less, more preferably 80 Å or more and 230 Å or less, and further preferably 150 Å or more and 230 Å or less.

In addition, because of further improving the capabilities of adsorbing cesium and strontium, the crystalline silicotitanate has the mass ratio of the potassium content in terms of K₂O to A₂O (K₂O/A₂O) is more than 0% by mass and 40% by mass or less and preferably 5% by mass or more and 40% by mass or less.

The adsorbent used in the treatment method of the present invention is a granular adsorbent having a grain size of 250 μm or more and 1200 μm or less, preferably 300 μm or more and 800 μm or less, and more preferably 300 μm or more and 600 μm or less, and is prepared from an alkali metal salt of a hydrous crystalline silicotitanate. The granular adsorbent of the present invention has a finer grain size and a higher adsorption rate as compared with commercially available common adsorbents (for example, zeolite-based adsorbents are pellets having a grain size of approximately 1.5 mm). On the other hand, when a powdery adsorbent is packed within the adsorption column, and water is passed through the adsorption column, the powdery adsorbent flows out the column. Thus, it is preferred that the granular adsorbent used in the present invention has a predetermined grain size. The granular adsorbent may be prepared by subjecting a mixed gel of a hydrous crystalline silicotitanate and a titanate salt to known granulation methods such as stirring mixing granulation, tumbling granulation, extrusion granulation, crushing granulation, fluidized bed granulation, spray dry granulation, compression granulation, and melt granulation. The granulation methods may be performed with or without known binders such as polyvinyl alcohol, polyethylene oxide, hydroxyethyl cellulose, hydroxypropyl cellulose, hydroxypropyl methyl cellulose, hydroxyethyl methyl cellulose, carboxymethyl cellulose, hydroxypropyl methyl cellulose, methyl cellulose, ethyl cellulose, starch, corn starch, syrup, lactose, gelatin, dextrin, gun arabic, alginic acid, polyacrylic acid, glycerin, polyethylene glycol, polyvinylpyrrolidone, and alumina. The granular adsorbent granulated without using a binder is preferable in the treatment method of the present invention using the adsorbent packed within the adsorbent column, since the adsorbent quantity per unit volume is increased, and thus the treatment amount per unit volume of the same adsorption column is increased. Alternatively, the granular adsorbent having a grain size falling within a predetermined range can be obtained by drying the mixed gel of the hydrous crystalline silicotitanate and titanate salt, crushing the mixture into a granular form and classifying the granule with a sieve.

The granular adsorbent having a grain size falling within the above-described predetermined range used in the present invention preferably has a strength of 0.1 N or more in a wet condition, and does not collapse under the pressure (in general, 0.1 MPa to 1.0 MPa) applied by passing the radioactive waste water to be treated for a long period of time.

The adsorbent used in the present invention can be produced by adopting a first step of mixing a silicic acid source, titanium tetrachloride, water, and at least one of a sodium compound and a potassium compound, to obtain a mixed gel; and a second step of allowing the mixed gel obtained by the first step to undergo hydrothermal reaction, wherein in the first step, the silicic acid source and titanium tetrachloride are added so as for the molar ratio between Ti and Si contained in the mixed gel to be Ti/Si=1.2 or more and 1.5 or less; the total of the concentration of the silicic acid source in terms of SiO₂ and the concentration of titanium tetrachloride in terms of TiO₂ to be 2% by mass or more and 40% by mass or less; and the molar ratio between A₂O and SiO₂ to be A₂O/SiO₂=0.5 or more and 2.5 or less.

Examples of the silicic acid source used in the first step include sodium silicate. In addition, examples of the silicic acid source also include an active silicic acid obtained by cationic exchange of an alkali silicate (namely, an alkali metal salt of silicic acid). The active silicic acid is obtained by bringing an alkali silicate aqueous solution into contact with, for example, a cationic exchange resin to perform a cationic exchange. As the alkali silicate aqueous solution, a sodium silicate aqueous solution usually called a liquid glass (for example, liquid glass No. 1 to liquid glass No. 4) is suitably used. An alkali silicate aqueous solution prepared by dissolving an alkali metasilicate in a solid form in water may be used. An alkali metasilicate is produced through a crystallization step, and hence is sometimes small in the content of impurities. The alkali silicate aqueous solution is used as diluted with water, if necessary. As the cationic exchange resin used when the active silicic acid is prepared, any suitable known cationic exchange resins can be used, without being particularly limited. In the step of contacting the alkali silicate aqueous solution and the cationic exchange resin with each other, for example, the alkali silicate aqueous solution is diluted with water so as for the silica concentration to be 3% by mass or more and 10% by mass or less, and then the diluted alkali silicate aqueous solution is brought into contact with a H-type strongly acidic or weakly acidic cationic exchange resin to be dealkalized. Moreover, if necessary, a deanionization can also be applied by bringing the diluted alkali silicate aqueous solution into contact with an OH-type strongly basic anionic exchange resin. By this step, an active silicic acid aqueous solution is prepared.

Examples of the sodium compound used in the first step include sodium hydroxide and sodium carbonate. In addition, examples of the potassium compound include potassium hydroxide and potassium carbonate.

When a sodium compound and a potassium compound are used in the first step, the proportion of the number of moles of the potassium compound in relation to the total number of moles of the sodium compound and the potassium compound is preferably larger than 0% and 50% or less and more preferably 5% or more and 30% or less.

The silicic acid source and titanium tetrachloride are added so as for the molar ratio Ti/Si between the Ti originating from titanium tetrachloride and the Si originating from the silicic acid source in the mixed gel to be 1.2 or more and 1.5 or less. As a result of the investigation performed by the present inventors, by setting the ratio Ti/Si in the mixed gel within the above-described molar ratio range, a crystalline silicotitanate being high in the degree of crystallinity and having a crystallite diameter and a half width falling within the above-described ranges can be obtained more easily.

In the first step, the silicic acid source, the sodium compound, the potassium compound, and titanium tetrachloride can be each added to the reaction system in a form of an aqueous solution. In some cases, these ingredients can also be each added in a solid form. Moreover, in the first step, the concentration of the obtained mixed gel can be adjusted, if necessary, by using pure water in the obtained mixed gel.

In the first step, the silicic acid source, the sodium compound, the potassium compound, and titanium tetrachloride can be added in various addition orders. For example, here may be suitably mentioned (1) an order in which titanium tetrachloride is added to the mixture of the silicic acid source, water, and at least one of the sodium compound and the potassium compound, or (2) an order in which at least one of the sodium compound and the potassium compound is added to the mixture of the active silicic acid aqueous solution obtained by cationic exchange of an alkali silicate, titanium tetrachloride and water.

In the first step, the sodium compound and/or the potassium compound is preferably added so as for the total concentration (the concentration of A₂O) of sodium and potassium in the mixed gel in terms of Na₂O to be 0.5% by mass or more and 15.0% by mass or less, and in particular, 0.7% by mass or more and 13% by mass or less. The total mass of sodium and potassium in the mixed gel in terms of Na₂O, and the total concentration of sodium and potassium in the mixed gel in terms of Na₂O (hereinafter, referred to as “the total concentration of sodium and potassium (in the case where no potassium compound is used in the first step, the sodium concentration)”) is calculated by using the following formulas:

Total mass (g) of sodium and potassium in mixed gel in terms of Na₂O=(number of moles of A−number of moles of chloride ions originating from titanium tetrachloride)×0.5×molecular weight of Na₂O [Formula 1]

Total concentration (% by mass) of sodium and potassium in mixed gel in terms of Na₂O=total mass (g) of sodium and potassium in mixed gel in terms of Na₂O/(mass of water in mixed gel+total mass (g) of sodium and potassium in mixed gel in terms of Na₂O)×100 [Formula 2]

When sodium silicate is used as the silicic acid source, the sodium component in the sodium silicate simultaneously serves as a sodium source in the mixed gel. Therefore, “the mass (g) of sodium in the mixed gel in terms of Na₂O” as referred to herein is calculated as the sum of all the sodium components in the mixed gel. Similarly, “the mass (g) of potassium in the mixed gel in terms of Na₂O” is also calculated as the sum of all the potassium components in the mixed gel.

In the first step, it is desired, in order to obtain a uniform gel, that a titanium tetrachloride aqueous solution is added over a certain period of time in a stepwise manner or continuously. For that purpose, a Perista pump or the like can be suitably used for the addition of titanium tetrachloride.

The mixed gel obtained in the first step is preferably subjected to aging, before performing the below-described second step of the hydrothermal reaction, over a period of time of 0.1 hour or more and 5 hours or less, at 10° C. or higher and 100° C. or lower, for the purpose of obtaining a uniform product.

The mixed gel obtained in the first step is subjected to the second step of the hydrothermal reaction, and thus a crystalline silicotitanate is obtained. The hydrothermal reaction is not limited with respect to the conditions as long as the conditions of the hydrothermal reaction allow a crystalline silicotitanate to be synthesized. Usually, the hydrothermal reaction is allowed to proceed under pressure in an autoclave, at a temperature of preferably 120° C. or higher and 200° C. or lower, and further preferably 140° C. or higher and 180° C. or lower, over preferably 6 hours or more and 90 hours or less, and further preferably 12 hours or more and 80 hours or less. The reaction time can be selected according to the scale of the synthesis apparatus.

The hydrated product containing the crystalline silicotitanate obtained in the second step is subjected to a granulation into a granular form, and classified as a grain size of 250 μm or more and 1200 μm or less. The classification can be performed by a common method using a sieve having a predetermined opening.

In the treatment method of the present invention, the adsorbent is packed within an adsorption column so as for the layer height to be 10 cm or more and 300 cm or less, preferably 20 cm or more and 250 cm or less, and more preferably 50 cm or more and 200 cm or less. In the case where the layer height is less than 10 cm, the adsorbent layer cannot be packed uniformly when the adsorbent is packed in the adsorption column, thus the water is not uniformly passed through the adsorbent layer, and consequently the treated water quality is degraded. Increasing the layer height is preferable since an appropriate pressure difference of passing water can be achieved, the treated water quality is stabilized, and the total amount of the treated water is increased; however, a layer height of 300 cm or less is preferable in consideration of the pressure difference of passing water from the viewpoint of practicability.

The radioactive waste water containing radioactive cesium and radioactive strontium are passed through the adsorption column packed within the adsorbent, at a linear velocity (LV) of 1 M/h or more and 40 m/h or less, preferably 5 m/h or more and 30 m/h or less, more preferably 10 m/h or more and 20 mill or less, and at a space velocity (SV) of 200 h⁻¹ or less, preferably 100 h⁻¹ or less, more preferably 50 h⁻¹ or less, preferably 5 h⁻¹ or more, more preferably 10 h⁻¹ or more. The linear velocity is preferably 40 m/h or less in consideration of the pressure difference of passing water, and is preferably 1 m/h or more in consideration of the quantity of water to be treated. Even at the space velocity (SV) used in common waste water treatment of 20 h⁻¹ or less, in particular, approximately 10 h⁻¹, the effect of the adsorbent of the present invention can be achieved; however, a waste water treatment using a common adsorbent cannot achieve a stable treated water quality, and cannot achieve a removal effect. In the present invention, the linear velocity (LV) and the space velocity (SV) can be increased without increasing the size of the adsorption column larger.

The linear velocity (LV) is the value obtained by dividing the water quantity (m³/h) passed through the adsorption column by the cross-sectional area (m²) of the adsorption column. The space velocity (SV) is the value obtained by dividing the water quantity (m³/h) passed through the adsorption column by the volume (m³) of the adsorbent packed in the adsorption column.

### EXAMPLES

Hereinafter, the present invention is described specifically by way of Examples and Comparative Examples, but the present invention is not limited to these Examples. The analyses of the various components and the various adsorbents were performed using the apparatuses and under the conditions described below.

<Cesium Concentration and Strontium Concentration>

Quantitative analysis of Cesium 133 and strontium 88 was performed by using an inductively coupled plasma mass spectrometer (ICP-MS, Model: Agilent 7700x) manufactured by Agilent Technologies, Inc. The measurement wavelength of Cs was set at 697.327 nm, and the measurement wavelength of Sr was set at 216.596 nm. The standard samples used were as follows: the aqueous solutions each containing 0.3% of NaCl, and containing 100 ppm, 50 ppm and 10 ppm of Cs, respectively; and the aqueous solutions each containing 0.3% of NaCl, and containing 100 ppm, 10 ppm and 1 ppm of Sr, respectively. Acidic samples to be analyzed were prepared by diluting samples by a factor 1000 with a dilute nitric acid.

### Production Examples 1 to 3

(1) First Step

Mixed aqueous solutions were obtained by mixing and stirring sodium silicate (manufactured by Nippon Chemical Industrial Co., Ltd. [SiO₂: 28.96%, Na₂O: 9.37%, H₂O: 61.67%, SiO₂/Na₂O=3.1]), 25% caustic soda (industrial 25% sodium hydroxide, NaOH: 25%, H₂O: 75%), 85% caustic potash (solid reagent, potassium hydroxide, KOH: 85%) and pure water in the amounts shown in Table 1. To each of the obtained mixed aqueous solutions, a titanium tetrachloride aqueous solution (36.48% aqueous solution, manufactured by OSAKA Titanium Technologies Co., Ltd.) was continuously added in the amount shown in Table 1, with a Perista pump over 0.5 hour to produce a mixed gel. The obtained mixed gels were allowed to stand still for aging over 1 hour at room temperature (25° C.) after the addition of the titanium tetrachloride aqueous solution.

(2) Second Step

The obtained mixed gels in the first step were placed in an autoclave, increased in temperature to 170° C. over 1 hour, and reacted at this temperature while stirring. Each slurry after the reaction was filtered, washed, and dried to yield an aggregated crystalline silicotitanate.

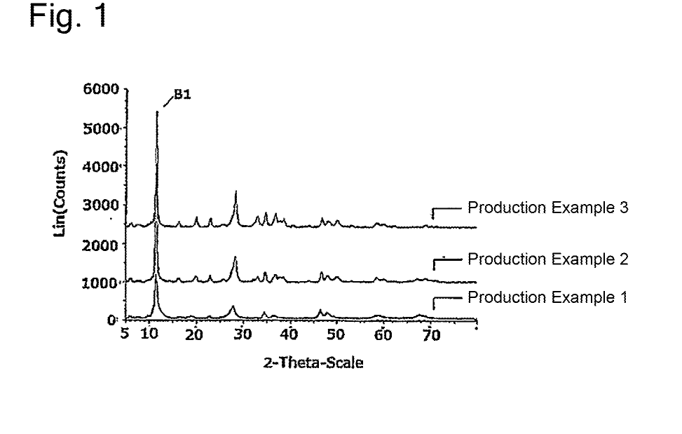

The compositions determined from the X-ray diffraction analysis and the contents of Na and K determined from the ICP analysis of the obtained crystalline silicotitanate are shown in Table 2, the half widths and the crystallite diameters of the obtained crystalline silicotitanates are shown in Table 3, and the X-ray diffraction charts of the obtained crystalline silicotitanates are shown in FIG. 1.

TABLE 1
Production Conditions

| | | Production Examples | | |
|---|---|---|---|---|
| | | 1 | 2 | 3 |
| Charged | Sodium silicate No. 3 | 60 | 60 | 90 |
| amounts | Silica gel | — | — | — |
| (g) | Titanium tetrachloride solution | 203.3 | 203.3 | 203.3 |
| | 25% Caustic soda | 308.2 | 224.3 | 139.8 |
| | 85% Caustic potash | — | 34.5 | 69.4 |
| | Ion-exchange water | 33.2 | 82.5 | 132.2 |
| Mixed gel | Molar ratio Ti/Si | 1.33 | 1.33 | 1.33 |
| | Molar ratio K₂O/Na₂O | 0/100 | 25/75 | 50/50 |
| | a: Concentration in terms of | 2.83 | 2.83 | 4.04 |
| | SiO₂ (%) | | | |
| | b: Concentration in terms of | 5.14 | 5.14 | 4.9 |
| | TiO₂ (%) | | | |
| | a + b | 7.97 | 7.97 | 8.94 |
| | Molar ratio A₂O/SiO₂ | 0.926 | 0.926 | 0.721 |
| | Concentration in terms of | 3.64 | 3.71 | 4.2 |
| | Na₂O (%) | | | |
| Reaction | Reaction temperature (° C.) | 170 | 170 | 170 |
| conditions | Reaction time (h) | 96 | 96 | 96 |

TABLE 2
Contents of Na and K Determined from ICP Analysis

| | | Content | Content |
|---|---|---|---|
| | | of | of |
| | | Na₂O | K₂O |
| | | (% by | (% by |
| | X-ray diffraction structure | mass) | mass) |
| Production | Single phase Na₄Ti₄Si₃O₁₆•6H₂O; other | 20 | 0 |
| Examples 1 | crystalline silicotitanates and TiO₂ | | |
| | were not detected. | | |
| Production | Single phase A₄Ti₄Si₃O₁₆•6H₂O | 12.7 | 8.3 |
| Examples 2 | (A = Na and K); other crystalline | | |
| | silicotitanates and TiO₂ were not | | |
| | detected. | | |
| Production | Single phase A₄Ti₄Si₃O₁₆•6H₂O | 11.1 | 10.8 |
| Examples 3 | (A = Na and K); other crystalline | | |
| | silicotitanates and TiO₂ were not | | |
| | detected. | | |

TABLE 3
Half Widths and Crystallite Diameters

| | Half width (°) | Crystallite diameter (Å) |
|---|---|---|
| Production Examples 1 | 0.77 | 108 |
| Production Examples 2 | 0.42 | 201 |
| Production Examples 3 | 0.41 | 202 |
| Comparative Example 1 | 2.39 | 35 |

The slurry containing each of the above-described crystalline silicotitanates was placed in a cylindrical extruder equipped, at the distal end portion thereof, with a screen having a perfect circle equivalent diameter of 0.6 mm, and the slurry was extrusion molded. The hydrous molded body extruded from the screen was dried at 120° C. for 1 day, under atmospheric pressure. The obtained dried product was lightly crushed, and then sieved with a sieve having an opening of 600 μm. The residue on the sieve was again crushed, and the whole amount of crushed residue was sieved with a sieve having an opening of 600 μm. Next, the whole amount having passed through the sieve having an opening of 600 μm was collected and sieved with a sieve having an opening of 300 μm, and the residue on the sieve was collected and was adopted as a sample.

### Example 1

<Preparation of Simulated Contaminated Seawater 1>

By adopting the following procedures, simulated contaminated water containing non radiative cesium and strontium, simulating the contaminated water of Fukushima Daiichi Nuclear Power Station was prepared.

First, an aqueous solution was prepared so as to have a salt concentration of 3.0% by mass by using a chemical for producing artificial seawater of Osaka Yak en Co., Ltd., MARINE ART SF-1 (sodium chloride: 22.1 g/L, magnesium chloride hexahydrate: 9.9 g/L, calcium chloride dihydrate: 1.5 g/L, anhydrous sodium sulfate: 3.9 g/L, potassium chloride: 0.61 g/L, sodium hydrogen carbonate: 0.19 g/L, potassium bromide: 96 mg/L, borax: 78 mg/L, anhydrous strontium chloride: 0.19 g/L, sodium fluoride: 3 mg/L, lithium chloride: 1 mg/L, potassium iodide: 81 μg/L, manganese chloride tetrahydrate: 0.6 μg/L, cobalt chloride hexahydrate: 2 μg/L, aluminum chloride hexahydrate: 8 μg/L, ferric chloride hexahydrate: 5 μg/L, sodium tungstate dihydrate: 2 μg/L, ammonium molybdate tetrahydrate: 18 μg/L). To the prepared aqueous solution, cesium chloride was added so as for the cesium concentration to be 1 mg/L, and thus the simulated contaminated seawater 1 having a cesium concentration of 1.0 mg/L was prepared. A fraction of the simulated contaminated seawater 1 was sampled, and analyzed with ICP-MS; consequently, the cesium concentration was found to be 1.09 mg/L, and the strontium concentration was found to be 6.52 mg/L.

The adsorbent having a grain size of 300 μm or more and 600 μm or less, prepared in Production Example 2, was crushed in a mortar, a 100-ml Erlenmeyer flask was charged with 0.5 g of the crushed adsorbent, 50 ml of the simulated contaminated seawater 1 was added in the flask and allowed to stand still for 7 days; then a fraction of the simulated contaminated seawater 1 was sampled, and the cesium and strontium concentrations were measured; the cesium concentration was found to be 0.04 mg/L, and the strontium concentration was found to be 2.46 mg/L.

As Comparative Example, a test was implemented by using a crystalline silicotitanate represented by Na_{8.72}Ti₅Si₁₂O₃₈.nH₂O, in the same procedures as described above.

From the cesium and strontium concentrations before and after the treatment with the adsorbent the removal rates of cesium and strontium were calculated. The results thus obtained are shown in Table 4. As can be seen from Table 4, the adsorbent of the present invention is higher in the removal rates of cesium and strontium than the crystalline silicotitanate used as Comparative Example, and both of cesium and strontium were able be removed by adsorption.

TABLE 4
Removal Rates of Cs and Sr

| | Cs removal rate | Sr removal rate |
|---|---|---|
| Example 1 | 95% | 58% |
| Comparative Example | 83% | 27% |

### Example 2

<Preparation of Simulated Contaminated Seawater 2>

By adopting the following procedures, simulated contaminated water containing non radiative cesium and strontium, simulating the contaminated water of Fukushima Daiichi Nuclear Power Station was prepared.

First, an aqueous solution was prepared so as to have a salt concentration of 0.17% by mass by using a chemical for producing artificial seawater of Osaka Yakken Co., Ltd., MARINE ART SF-1. To the prepared aqueous solution, cesium chloride was added so as for the cesium concentration to be 1 mg/L, and thus the simulated contaminated seawater 2 having a cesium concentration of 1.0 mg/L was prepared. A fraction of the simulated contaminated seawater 2 was sampled, and analyzed with ICP-MS; consequently, the cesium concentration was found to be 0.81 mg/L to 1.26 mg/L, and the strontium concentration was found to be 0.26 mg/L to 0.42 mg/L.

A glass column having an inner diameter of 16 mm was packed with 20 ml of the adsorbent having a grain size of 300 μm to 600 μm, prepared in Production Example 2, so as for the layer height to be 10 cm; the simulated contaminated seawater 2 was passed through the column at a flow rate of 67 ml/min (linear velocity (LV): 20 m/h, space velocity (SV): 200 h⁻¹); and the outlet water was periodically sampled, and the cesium concentration and the strontium concentration were measured. The results of the analysis of the outlet water were such that the cesium concentration was 0.00 mg/L to 0.59 mg/L, and the strontium concentration was 0.00 mg/L to 0.31 mg/L.

As Comparative Example, a test was implemented by using a crystalline silicotitanate represented by Na_{8.72}Ti₅Si₁₂O₃₈.nH₂O in the same procedures as described above.

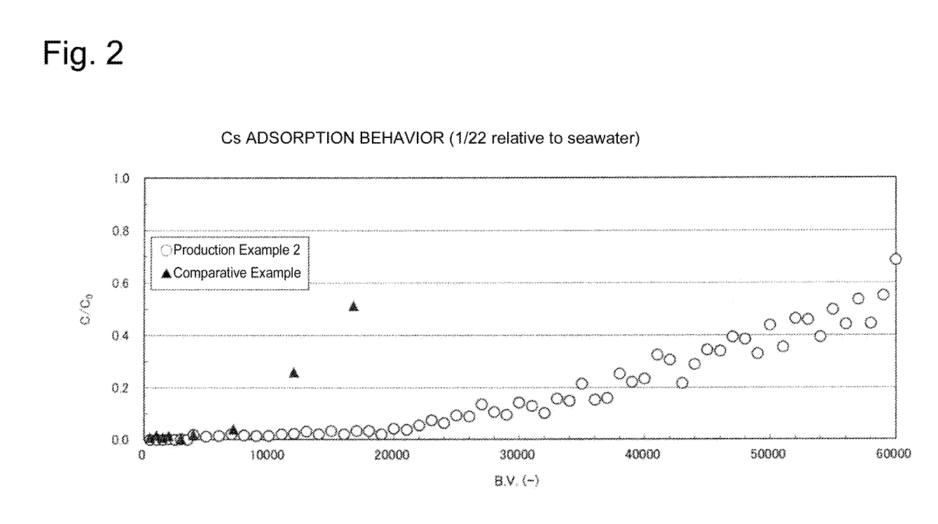

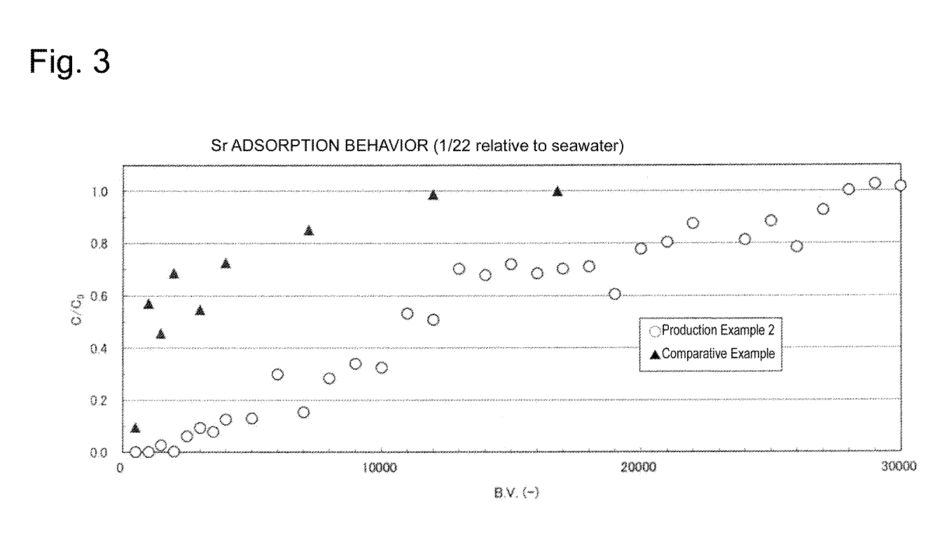

The cesium removal performance is shown in FIG. 2, and the strontium removal performance is shown in FIG. 3. In each of FIGS. 2 and 3, the horizontal axis is the B.V. representing the ratio of the volume of the simulated contaminated seawater passing through the column to the volume of the adsorbent; the vertical axis represents the value obtained by dividing the cesium or strontium concentration at the column outlet by the cesium or strontium concentration at the column inlet, respectively.

As can be seen from FIG. 2, even when the layer height was 10 cm and the space velocity (S V) was 200 h⁻¹, cesium was able to be removed by adsorption to an extent of nearly 100% for the B.V. up to approximately 20000.

As can be seen from FIG. 3, when the layer height of the adsorbent in the adsorption column was 10 cm, and the space velocity (SV) was 200 h⁻¹, the adsorption removal performance of strontium is lower as compared with the adsorption removal performance of cesium; however, for the B.V. up to approximately 5000, strontium was able to be removed to an extent of approximately 80%, and for the B.V. up to 10000, strontium was able to be removed to an extent of approximately 60%.

The B.V. values associated with the ratios (C/C₀) of the column outlet concentration (C) to the column inlet concentration (C₀) of 1.0 for cesium and 0.1 for strontium are as large as 28000 for cesium and as large as 30000 for strontium; thus, it can be said that a very large amount of the simulated contaminated seawater can be treated.

### Example 3

A glass column having an inner diameter of 16 mm was packed with 200 ml of the adsorbent having a grain size of 300 μm or more and 600 μm or less, prepared in Production Example 2, so as for the layer height to be 10 cm; the simulated contaminated seawater 3 (cesium concentration: 0.83 mg/L to 1.24 mg/L, strontium concentration: 0.29 mg/L to 0.44 mg/L) prepared in the same manner as the simulated contaminated seawater 2 was passed through the column at a flow rate of 6.5 ml/min (linear velocity (LV): 2 m/h, space velocity (SV): 20 h⁻¹); and the outlet water was periodically sampled, and the cesium concentration and the strontium concentration were measured.

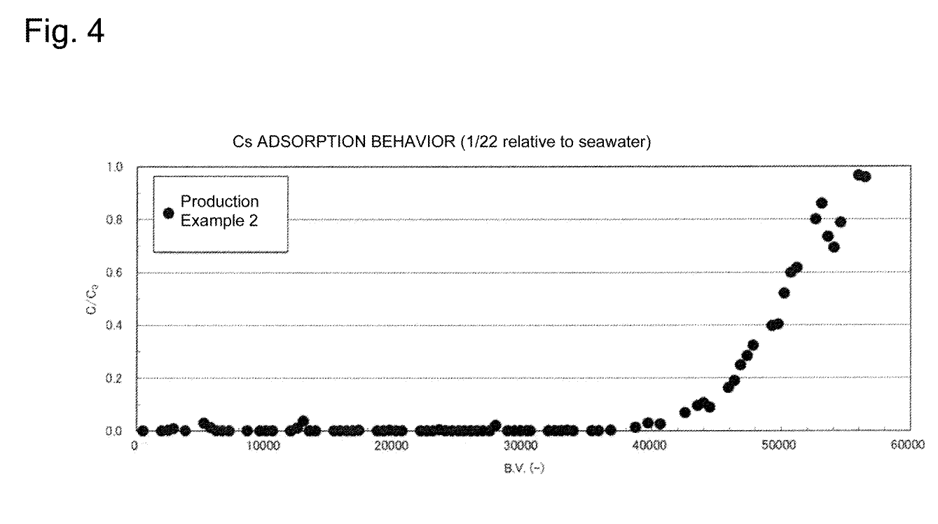

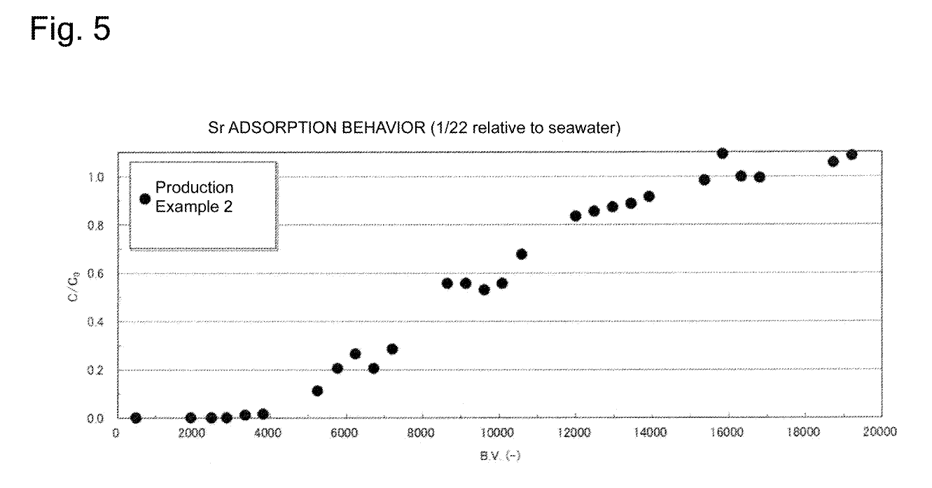

The cesium removal performance is shown in FIG. 4, and the strontium removal performance is shown in FIG. 5. In each of FIGS. 4 and 5, the horizontal axis is the B.V. representing the ratio of the volume of the simulated contaminated seawater passing through the column to the volume of the adsorbent; the vertical axis represents the value obtained by dividing the cesium or strontium concentration at the column outlet by the cesium or strontium concentration at the column inlet, respectively. The results of the analysis of the outlet water were such that the cesium concentration was 0.00 mg/L to 0.89 mg/L, and the strontium concentration was 0.00 mg/L to 0.38 mg/L.

As can be seen from FIG. 4, cesium was able to be removed by adsorption to an extent of nearly 100% for the B.V. up to approximately 40000. From a comparison of FIG. 4 with FIG. 2, it can be said that for the adsorption removal of cesium, the adsorption removal performance of cesium is markedly higher in the case of the space velocity (SV) of 20 h⁻¹ than the case of the space velocity (SV) of 200 h⁻¹.

As can be seen from FIG. 5, strontium was able to be removed by adsorption to an extent of nearly 100% for the B.V. up to approximately 5000, and was able to be removed to an extent of approximately 70% for the B.V. of 7000. As can be seen from a comparison of FIG. 5 with FIG. 3, by setting the space velocity (SV) to be 20 h⁻¹, the adsorption removal performance of strontium was remarkably improved within the range of B.V. up to approximately 5000.

Accordingly, it has been able to be verified that by decreasing the space velocity (SV), the adsorption removal performances of cesium and strontium are remarkably improved.

What is claimed is:

1. A treatment method of radioactive waste water containing radioactive cesium and radioactive strontium, comprising passing the radioactive waste water containing radioactive cesium and radioactive strontium through an adsorption column packed with an adsorbent for cesium and strontium, to adsorb the radioactive cesium and radioactive strontium on the adsorbent,
wherein the adsorbent for cesium or strontium comprises a crystalline silicotitanate having a crystallite diameter of 60 Å or more and having a half width of 0.9° or less of the diffraction peak in the lattice plane (100), the crystalline silicotitanate represented by the general formula: A₄Ti₄Si₃O₁₆.nH₂O wherein A is Na or K or a combination thereof, and n represents a number of 0 to 8,
wherein the adsorbent for cesium and strontium is a granular adsorbent having a grain size of 250 μm or more and 1200 μm or less,
wherein the absorbent is packed to a height of 10 cm or more and 300 cm or less in the adsorption column, and
wherein the radioactive waste water is passed through the adsorption column at a linear velocity (LV) of 1 m/h or more and 40 m/h or less and a space velocity (SV) of 200 h⁻¹ or less.

2. The treatment method according to claim 1, wherein the radioactive waste water is waste water containing a Na ion, a Ca ion and/or a Mg ion.

3. The treatment method according to claim 1, wherein the adsorbent comprises 99.5% by mass or more of the crystalline silicotitanate.

4. The treatment method according to 2, wherein the adsorbent comprises 99.5% by mass or more of the crystalline silicotitanate.
